(19) United States
(12) Patent Application Publication
(10) Pub. No.: US 2023/0039494 A1
(43) Pub. Date: Feb. 9, 2023

(54) ELECTROMAGNETIC DEVICE FOR CONVERTING ENERGY

(71) Applicant: COMMISSARIAT À L'ÉNERGIE ATOMIQUE ET AUX ÉNERGIES ALTERNATIVES, Paris (FR)

(72) Inventors: Marc Bohnke, Grenoble (FR); Léana Ciobanu, Grenoble (FR); Ulrich Soupremanien, Grenoble (FR); Gérard Delette, Grenoble (FR)

(21) Appl. No.: 17/758,741

(22) PCT Filed: Jan. 15, 2021
(86) PCT No.: PCT/FR2021/050070

§ 371 Date: Jul. 13, 2022

(30) Foreign Application Priority Data
Jan. 16, 2020 (FR) FR2000391

(51) Int. Cl. H01F 27/28; H01F 27/00; H01F 27/02; H01F 27/24

(52) U.S. Cl. CPC H01F 27/2895; H01F 27/006; H01F 27/022; H01F 27/025; H01F 27/24

(57) ABSTRACT

An electromagnetic device for converting energy comprises: a ferromagnetic core of essentially planar shape and delimited by a peripheral contour; a primary winding and a secondary winding formed by primary turns and secondary turns, respectively. The device includes, arranged against the peripheral contour, a first block and a second block and a ferromagnetic material, and has a magnetic permeability lower than that of the ferromagnetic core. At least one primary turn and/or at least one secondary turn is formed around or passing through the first block and/or the second block to form, respectively, a first leakage inductance and/or a second leakage inductance.

### TECHNICAL FIELD

The present invention relates to an electromagnetic device for converting energy, especially provided with a transformer. The transformer according to the present invention comprises in particular an additional magnetic function for creating at least one controlled leakage inductance.

The means for implementing this additional magnetic function may also allow better thermal management of the transformer.

### PRIOR ART

High efficiency miniature power converters are nowadays commonly implemented in consumer electronic equipment, especially for charging them.

These converters, especially those comprising large-gap semiconductor components such as SiC (Silicon Carbide) or GaN (Gallium Nitride), can operate at powers in the order of one hundred watts, and at frequencies in the order of one Megahertz.

These converters require the integration of various components, in particular matching filters, DC-DC conversion elements and passive elements (voltage transformer, filter inductances, capacitors) in a limited volume, especially between 30 cm³ and 50 cm³, to achieve energy densities of 1.2 to 1.5 W/cm³ (20 to 25 W/inch³).

In addition to this integration effort, the converter is required to have a high level of electrical conversion efficiency.

In order to meet the latter requirements, materials implemented for the production of cores with relatively low magnetic losses (300 mW/cm³ at 25 mT and 1.5 MHz) have been developed. Ferrites, and more particularly NiZnFe₂O₄, are good candidates in this respect.

Regarding the component, the restrictions of dissipation of thermal losses by heating impose, in addition to the reduction in volume and the increase in efficiency, an adapted geometry and especially with a high form factor (higher than 20).

There is also a desire to add additional magnetic functions to these converters.

In particular, the converter comprises a transformer with a ferromagnetic core around which two windings are formed, called, respectively, the primary winding and secondary winding. This transformer is in particular for ensuring transformation of a current/voltage couple, applied across the primary winding, into another current/voltage couple delivered across the secondary winding.

In operation, a current flowing through the primary winding generates magnetic induction in the secondary winding, resulting in a current flowing in said secondary winding.

However, this magnetic induction, although mostly confined to the ferromagnetic core, is prone to magnetic leakages. These leakages give rise to a leakage inductance which essentially depends on the magnetic permeability of the ferromagnetic core and/or the geometry of the primary and secondary windings.

In a conventional transformer configuration, corresponding to a core surrounded by two primary and secondary windings, this leakage inductance is generally small, but it remains a problem, and its evaluation is difficult to predict.

Therefore, it is usually provided to add additional magnetic functions that make it possible to increase and control value of the leakage inductance and consequently to better predict the transformer behaviour. This leakage inductance can then act as a discrete inductance and replace it. Thus, the control of this leakage inductance would allow the removal of one or more passive components from the circuit.

However, the implementation of these functions is not always compatible with volume reduction restrictions of the transformer.

Therefore, one purpose of the present invention is to provide an electromagnetic conversion device incorporating a controlled leakage inductance that meets volume restrictions imposed on the converter.

Another purpose of the present invention is to provide an electromagnetic conversion device allowing better thermal management.

### DISCLOSURE OF THE INVENTION

The purposes of the present invention are, at least in part, achieved by an electromagnetic device for converting energy which comprises:
a ferromagnetic core of essentially planar shape and delimited by a peripheral contour;
a primary winding and a secondary winding formed by primary turns and secondary turns, respectively;

the device being characterised in that it comprises, arranged against the peripheral contour, a first block and a second block, comprising a ferromagnetic material, and having a magnetic permeability lower than that of the ferromagnetic core, and in that at least one primary turn and/or at least one secondary turn is formed around or passing through the first block and/or the second block to form, respectively, a first leakage inductance and/or a second leakage inductance.

According to one implementation, the set of primary turns is formed around the first block and the ferromagnetic core, and/or the set of secondary turns is formed around the second block and the ferromagnetic core.

According to one implementation, a first set of turns of the primary turns is formed exclusively around the first block, and/or a second set of the secondary turns is formed exclusively around the second block.

According to one implementation, the primary turns other than the turns of the first set are formed around the ferromagnetic core and the first block, and/or the secondary turns other than the turns of the second set are formed around the magnetic core and the second block.

According to one implementation, the primary turns other than the turns of the first set are formed exclusively around the ferromagnetic core, and/or the secondary turns other than the turns of the second set are formed exclusively around the ferromagnetic core.

According to one implementation, the ferromagnetic core forms a ring laterally delimited by the peripheral contour, the peripheral contour connecting an upper face and a lower face of said core.

According to one implementation, the first block and the second block belong to a continuous crown bearing against the peripheral contour.

According to one implementation, the crown connects a lower plate, bearing against the lower face of the core, and an upper plate, bearing against the upper face of the core, advantageously, the upper plate, the crown and the lower plate form a casing inside which the core is housed.

According to one implementation, the lower plate and/or the upper plate comprises one or more openings for removing heat likely to be generated during the operation of the electromagnetic device for converting energy.

According to one implementation, the primary winding and the secondary winding each comprise metal pins called primary pins and secondary pins, respectively, the primary pins and the secondary pins passing right through the lower plate and the upper plate.

According to one implementation, the device comprises two primary interconnection plates called the upper primary plate and lower primary plate, respectively, sandwiching the upper plate, the core and the lower plate, in this order, the lower primary plate and the upper primary plate each being provided on one of their faces with conductive tracks, called primary tracks, arranged so as to connect the primary pins at their ends and thus form the primary turns.

According to one implementation, the device comprises two secondary interconnection plates, called the upper secondary plate and lower secondary plate, respectively, sandwiching the upper primary plate, the upper plate, the core, the lower plate and the lower primary plate, in this order, the lower secondary plate and the upper secondary plate each being provided on one of their faces with conductive tracks, called secondary tracks, arranged to connect the secondary pins at their ends and thus form the secondary turns.

According to one implementation, an upper insulation plate, made of an electrically insulating material, is disposed between the upper primary plate and the upper secondary plate.

According to one implementation, a lower insulation plate made of an electrically insulating material is disposed between the lower primary plate and the lower secondary plate.

According to one implementation, the first block and the second block have a magnetic permeability of between 1 and 50.

According to one implementation, the ferromagnetic material comprises a ferrite type material, advantageously diluted in a polymer.

The invention also relates to a charger provided with the device according to the present invention.

The invention also relates to a USB plug provided with the charger according to the present invention.

### BRIEF DESCRIPTION OF THE DRAWINGS

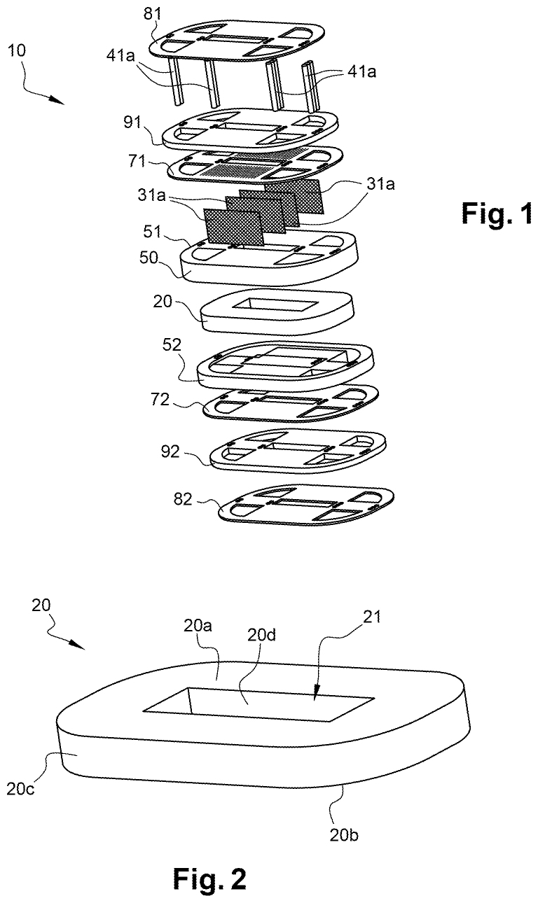

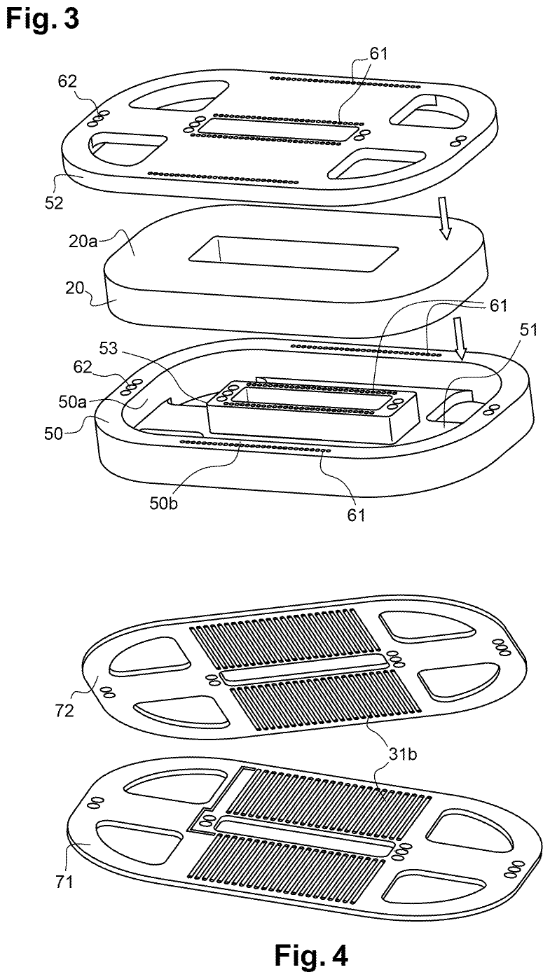

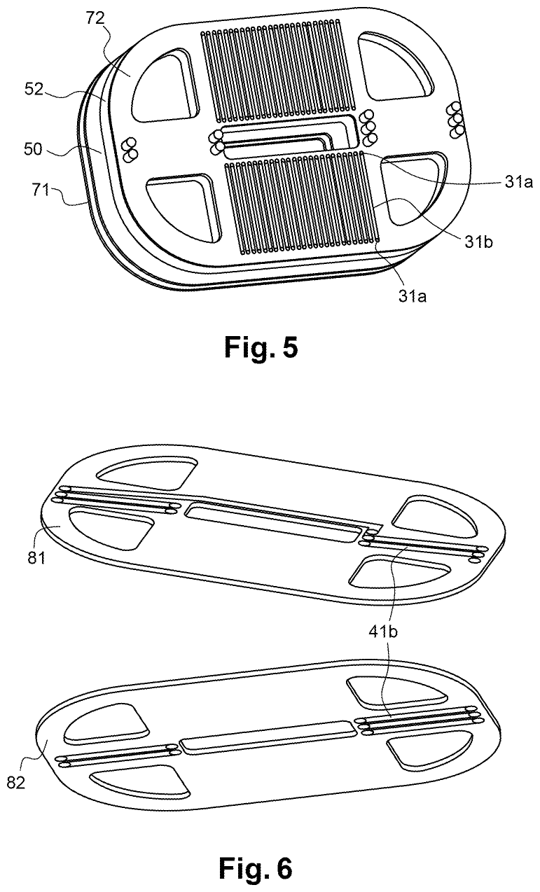

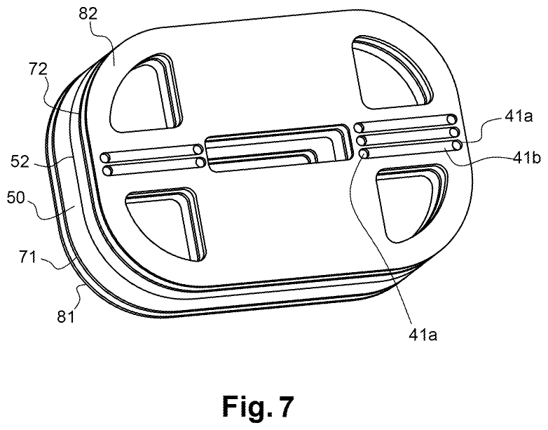

Further characteristics and advantages will become apparent in the following description of an electromagnetic device for converting energy, given as non-limiting examples, with reference to the attached drawings in which:

[FIG. 1] is a schematic representation in exploded view of the electromagnetic device for converting energy according to the present invention;

[FIG. 2] is a schematic representation of the core likely to be implemented within the scope of the present invention;

[FIG. 3] is a representation in exploded view of the core of FIG. 2 housed in a casing formed by the upper plate, the crown and the lower plate;

[FIG. 4] is a schematic representation of the upper primary plate and the lower primary plate;

[FIG. 5] is an illustration of the connection between the primary pins via the primary tracks;

[FIG. 6] is a schematic representation of the upper secondary plate and the lower secondary plate;

[FIG. 7] is an illustration of the connection between the secondary pins via the secondary tracks.

### DETAILED DISCLOSURE OF PARTICULAR EMBODIMENTS

The invention relates to an electromagnetic device for converting energy provided with at least one controlled leakage inductance. This controlled leakage inductance is especially implemented by the addition of a ferromagnetic block bearing against the core of the electromagnetic device for converting energy and around which at least one turn of one of the primary or secondary windings of said device is wound.

In FIGS. 1 to 7, an example of the implementation of an electromagnetic device for converting energy 10 according to the present invention can be seen. The conversion device 10 may especially be implemented in a charger.

In this respect, the conversion device represented in FIG. 1 comprises a ferromagnetic core 20 (FIG. 2) implemented in a transformer.

The ferromagnetic core 20 may have a magnetic permeability greater than 50 (μᵣ>50).

Furthermore, according to the present invention, the term “ferromagnetic material” indicates that it is a material with a magnetic permeability greater than 1.

The ferromagnetic core, especially when used in a transformer, comprises a ferromagnetic material, for example in the form of a single piece. In particular, this material has high values of relative magnetic permeability, for example greater than 50, and of saturation magnetic induction Bs, for example greater than 100 mT.

In this respect, due to their stable magnetic permeability at high frequencies, ferrite-type oxide materials with a spinel crystallographic structure are materials of choice. When implemented in an inductor core, such materials open the way for operation of said core at relatively high frequencies, and more particularly between 100 kHz and 10 MHz. The most common formulations of these materials are Mn₁₋ₓZnₓFe₂O₄ and Ni₁₋ₓZnₓFe₂O₄. These materials are also characterised by high electrical resistivity values that limit induced current losses.

As an example, the ferromagnetic core comprises Mn₁₋ₓZnₓFe₂O₄, with x between 0.3 and 0.6, the magnetic permeability μᵣ changes with x, and is between 500 and 1500.

The materials Mn₁₋ₓZnₓFe₂O₄ and Ni₁₋ₓZnₓFe₂O₄ also have the advantage of being available on an industrial scale.

The ferromagnetic core 20 may be of essentially planar shape, and more particularly have a ring shape.

The ring according to the present invention may be circular, oval, square, rectangular, possibly with rounded corners. However, the invention is not limited to these shapes only,

By “essentially planar shape” it is meant a core which has a thickness much smaller than its width or length. By “much smaller”, it is meant at least 10 times smaller. By much smaller, it is meant that the width is 2 to 100 times the thickness. A core of essentially planar shape is characterised by the fact that the quadrilateral formed by one of its sections has two sides of smaller dimensions than the other two.

The ring forming the ferromagnetic core especially comprises an upper face 20a and a lower face 20b, which are essentially parallel and are connected by a peripheral contour 20c.

It is also understood that the ferromagnetic core comprises a through opening 21 which extends from the lower face 20b towards the upper face 20a, and which is delimited by an inner wall 20d.

The conversion device 10 also comprises a primary winding and a secondary winding formed by primary turns and secondary turns, respectively.

It is understood that insofar as the device 10 according to the present invention is intended to perform an electromagnetic energy conversion, the primary turns and the secondary turns are, at least in part, formed around the ferromagnetic core 20.

By “formed around the ferromagnetic core”, it is meant turns surrounding a section, especially a continuous section, of the ferromagnetic core, and such that when an electric current flows through said turns, a magnetic flux flows, in a loop, through the core. Likewise, a time-varying magnetic flux flowing in the ring formed by the core generates, by induction, an electric current in the turns. In general, the section of the core can be in the form of an essentially straight or curved bar.

Thus, in operation, when a primary current of variable intensity flows in the primary winding, a variation in magnetic flux passes through the turns of the secondary winding formed around the ferromagnetic core 20, and consequently induces an electric current flowing in this same winding 40.

The conversion device 10 according to the present invention also comprises one or more first blocks 50a and one or more second blocks 50b (FIG. 3).

The first block 50a and the second block 50b comprise a ferromagnetic material which has a lower magnetic permeability than the ferromagnetic core 20a.

In particular, the first block 50a and the second block 50b may have a magnetic permeability between 1 and 50.

According to one advantageous embodiment, the ferromagnetic material forming the first block 50a and the second block 50b comprises a ferrite type material, advantageously diluted in a polymer.

In particular, the polymer may comprise a polyolefin and a shear thinning and/or lubricating agent.

Furthermore, according to the present invention at least one primary turn and/or at least one secondary turn is formed around the first block 50a and/or the second block 50b to form, respectively, a first leakage inductance and/or a second leakage inductance.

Advantageously, the first block 50a and the second block 50b are sections of a continuous crown 50 bearing against the peripheral contour 20c. The crown may be thicker than the first 50a and second 50b blocks.

According to one advantageous embodiment, the crown 50 may connect a lower plate 51, bearing against the lower face 20b of the core, and an upper plate 52, bearing against the upper face 20a of the ferromagnetic core 20 (FIGS. 1 and 3).

The crown, the upper plate and the lower plate may be made of the same material.

More particularly, the upper plate 52, the crown 50 and the lower plate 51 form a casing inside which the ferromagnetic core 20 is housed (FIG. 3).

Advantageously, the crown 50 and either of the lower plate 51 and upper plate 52 form a single piece.

In particular, the lower plate 51 may have the crown 50 mounted thereon.

The lower plate 51 may also comprise a central insert 53 fitting to the through opening of the ferromagnetic core 20 (FIG. 3).

Also advantageously, the upper plate 52, the crown 50 and the lower plate 51 may be formed by an overmoulding method on the ferromagnetic core 20.

In addition, primary holes 61 and secondary holes 62 are provided at the crown 50, the upper plate 52, the lower plate 51 and the central insert 53 for passing the primary winding and the secondary winding respectively.

The primary winding and the secondary winding may each comprise metal pins called, respectively, primary pins 31a and secondary pins 41a.

In particular, the primary pins 31a and the secondary pins 41a pass right through the lower plate 51 and the upper plate 52. The latter may also pass through the central insert 53 and the continuous crown 50.

Additional connections are implemented to ensure the electrical continuity of the first winding on the one hand and the second winding on the other.

In particular, the device may comprise two primary interconnection plates called, respectively, the upper primary plate 72 and lower primary plate 71 sandwiching, in this order, the upper plate 52, the ferromagnetic core 20 and the lower plate 51 (FIGS. 1 and 4).

Especially, the upper primary plate 72 and the lower primary plate 71 are provided, on either of their faces, with conductive tracks, called primary tracks 31b, intended to ensure the electrical continuity of the primary winding (FIG. 4).

The upper primary plate 72 and the lower primary plate 71 are, for example, printed circuit boards, and if necessary comprise holes through which the primary and secondary pins can pass.

Thus, the primary turns of the primary winding are formed by a succession of primary pins 31a and primary tracks 31b.

In this respect, FIG. 5 illustrates the connection between the primary pins 31a via the primary tracks 31b.

The device 10 may also comprise two secondary interconnection plates called, respectively, the upper secondary plate 82 and lower secondary plate 81, sandwiching the upper primary plate, the upper plate, the core, the lower plate and the lower primary plate, in this order (FIG. 1).

In particular, the lower secondary plate 81 and the upper secondary plate 82 are each provided on one of their faces with conductive tracks, called secondary tracks 41b, arranged to connect the secondary pins 41a at their ends and thus form the secondary turns (FIG. 6).

The lower secondary plate 81 and the upper secondary plate 82 are, for example, printed circuit boards, and if necessary include holes through which the secondary pins can pass.

Thus, the secondary turns of the secondary winding are formed by a succession of secondary pins 41a and secondary tracks 41b.

In this respect, FIG. 7 illustrates the connection between the secondary pins 41a via the secondary tracks 41b.

The conversion device 10 may also include an upper insulation plate 92, made of an electrically insulating material, and disposed between the upper secondary plate 82 and the upper primary plate 72, as well as a lower insulation plate 91, made of an electrically insulating material, and disposed between the lower secondary plate 81 and the lower primary plate 71 (FIG. 1).

By “electrically insulating” it is meant a dielectric material which has a dielectric strength (or rigidity) for electric fields of less than 6000 V/mm intensity.

Considering turns formed by pins and conductive tracks makes it easier to form them, particularly when they are to be integrated into a small electromagnetic device for converting energy. Indeed, a winding made of a conductive wire will have more difficulty in closely fitting to the shape of the ferromagnetic core when the size thereof decreases.

Furthermore, the crown (or the first and second blocks), which has a magnetic function, allows creation of controlled leakage inductances, and prepares the ground for implementing the conversion device in an LLC topology devoid of a resonance function.

The crown, and more particularly the casing that it forms with the upper plate and the lower plate, also has a screening function with respect to the external environment. In particular, this shielding allows the conversion device to be positioned close to other components without affecting their operation.

The casing also allows dissipation of the amount of heat generated when the device is in operation, and thus allows easier integration of the device 10 with the other components of a charger.

The crown also provides mechanical function and supports the ferromagnetic core and the primary and secondary windings.

In addition, the crown increases the power density of the converter.

The invention has been described by requiring the set of primary turns to be formed around the first block and the core, and the set of secondary turns to be formed around the second block and the core. However, the present invention also covers other arrangements.

In particular, a first set of turns of the primary turns is formed exclusively around the first block, and/or a second set of the secondary turns is formed exclusively around the second block.

According to one first alternative, the primary turns other than the turns of the first set are formed around the ferromagnetic core and the first block, and/or the secondary turns other than the turns of the second set are formed around the magnetic core and the second block.

According to one second alternative, the primary turns other than the turns of the first set are formed exclusively around the ferromagnetic core, and/or the secondary turns other than the turns of the second set are formed exclusively around the ferromagnetic core.

The arrangement of the holes and/or passage of the primary and secondary turns in the various elements of the device 10 is within reach of the person skilled in the art, and is in particular a function of these considerations.

What is claimed is:

1.-18. (canceled)

19. An electromagnetic device for converting energy (10) which comprises:
a ferromagnetic core (20) of essentially planar shape and delimited by a peripheral contour (20c);
a primary winding and a secondary winding formed, respectively, by primary turns (31a, 31b) and secondary turns (41a, 41b); and
arranged against the peripheral contour (20c), a first block (50a) and a second block (50b), comprising a ferromagnetic material, and having a magnetic permeability lower than that of the ferromagnetic core (20),
wherein at least one primary turn (31a, 31b) and/or at least one secondary turn (41a, 41b) is formed around or through the first block (50a) and/or the second block (50b) to form, respectively, a first leakage inductance and/or a second leakage inductance.

20. The device according to claim 19, wherein the set of primary turns (31a, 31b) is formed around the first block (50a) and the ferromagnetic core (20), and/or the set of secondary turns (41a, 41b) is formed around the second block (50b) and the ferromagnetic core (20).

21. The device according to claim 19, wherein a first set of turns of the primary turns (31a, 31b) is formed exclusively around the first block (50a), and/or a second set of the secondary turns (41a, 41b) is formed exclusively around the second block (50b).

22. The device according to claim 21, wherein the primary turns (31a, 31b) other than the turns of the first set are formed around the ferromagnetic core (20) and the first block (50a), and/or the secondary turns (41a, 41b) other than the turns of the second set are formed around the magnetic core and the second block (50b).

23. The device according to claim 21, wherein the primary turns (31a, 31b) other than the turns of the first set are formed exclusively around the ferromagnetic core (20), and/or the secondary turns (41a, 41b) other than the turns of the second set are formed exclusively around the ferromagnetic core (20).

24. The device according to claim 19, wherein the ferromagnetic core (20) forms a ring laterally delimited by the peripheral contour (20c), the peripheral contour (20c) connecting an upper face (20a) and a lower face (20b) of said core.

25. The device according to claim 24, wherein the first block (50a) and the second block (50b) belong to a continuous crown (50) bearing against the peripheral contour (20c).

26. The device according to claim 25, wherein the continuous crown (50) connects a lower plate (51), bearing against the lower face of the core, and an upper plate (52), bearing against the upper face (20a) of the core, advantageously, the upper plate (52), the continuous crown (50) and the lower plate form a casing inside which the core is housed.

27. The device according to claim 26, wherein the lower plate (51) and/or the upper plate (52) comprises one or more openings for removing heat likely to be generated during the operation of the electromagnetic device for converting energy.

28. The device according to claim 26, wherein the primary winding and the secondary winding each comprise metal pins called, respectively, primary pins (31a) and secondary pins (41a), the primary pins (31a) and the secondary pins (41a) passing right through the lower plate (51) and the upper plate (52).

29. The device according to claim 28, wherein the device comprises two primary interconnection plates called, respectively, the upper primary plate (72) and lower primary plate (71), sandwiching the upper plate (52), the core and the lower plate (51), in this order, the lower primary plate (71) and the upper primary plate (72) each being provided on one of their faces with conductive tracks, called primary tracks (31b), arranged to connect the primary pins (31a) at their ends and thus form the primary turns (31a, 31b).

30. The device according to claim 28, wherein the device comprises two secondary interconnection plates called the upper secondary plate (82) and lower secondary plate (81), respectively, sandwiching the upper primary plate (72), the upper plate (52), the core, the lower plate (51) and the lower primary plate (71), in this order, the lower secondary plate (81) and the upper secondary plate (82) each being provided on one of their faces with conductive tracks, called secondary tracks (41b), arranged to connect the secondary pins (41a) at their ends and thus form the secondary turns (41a, 41b).

31. The device according to claim 30, wherein an electrically insulating upper insulation plate is disposed between the upper secondary plate (82) and the upper primary plate (72).

32. The device according to claim 30, wherein an electrically insulating lower insulation plate is disposed between the lower secondary plate (81) and the lower primary plate (71).

33. The device according to one of claim 19, wherein the first block (50a) and the second block (50b) have a magnetic permeability of between 1 and 50.

34. The device according to claim 19, wherein the ferromagnetic material comprises a ferrite type material, advantageously diluted in a polymer.

35. A charger provided with the device according to claim 19.

36. A USB plug provided with the charger according to claim 35.
